(19) United States
(12) Patent Application Publication
(10) Pub. No.: US 2021/0012523 A1
(43) Pub. Date: Jan. 14, 2021

(54) Pose Estimation Method and Device and Storage Medium

(71) Applicant: Zhejiang SenseTime Technology Development Co., Ltd., Hangzhou (CN)

(72) Inventors: Xiaowei Zhou, Zhejiang (CN); Hujun Bao, Zhejiang (CN); Yuan Liu, Zhejiang (CN); Sida Peng, Zhejiang (CN)

(73) Assignee: Zhejiang SenseTime Technology Development Co., Ltd., Hangzhou (CN)

(21) Appl. No.: 17/032,830

(22) Filed: Sep. 25, 2020

Related U.S. Application Data
(63) Continuation of application No. PCT/CN2019/128408, filed on Dec. 25, 2019.

(30) Foreign Application Priority Data
Dec. 25, 2018 (CN) 201811591706.4

(51) Int. Cl. G06T 7/70; G06K 9/46; G06F 17/18; G06F 17/16

(52) U.S. Cl. CPC G06T 7/70; G06K 9/4671; G06T 2207/20076; G06F 17/16; G06F 17/18

(57) ABSTRACT

The present disclosure relates to a pose estimation method and device, an electronic apparatus, and a storage medium, the method comprising: performing keypoint detection processing on a target object in an image to be processed to obtain a plurality of keypoints of the target object in the image to be processed and a first covariance matrix corresponding to each keypoint; screening out a target keypoint from the plurality of keypoints in accordance with the first covariance matrix corresponding to each keypoint; and performing pose estimation processing in accordance with the target keypoint to obtain a rotation matrix and a displacement vector.

### CROSS-REFERENCE TO RELATED APPLICATIONS

The present application is a continuation of and claims priority under 35 U.S.C. § 120 to PCT Application. No. PCT/CN2019/128408, filed on Dec. 25, 2019, and titled “Pose Estimation Method and Apparatus, and Electronic Device and Storage Medium,” which claims the benefit of priority of Chinese Patent Application No. 201811591706.4, filed with the Chinese Patent Office on Dec. 25, 2018 and titled “Pose Estimation Method and Device, Electronic Apparatus and Storage Medium”. All the above referenced priority documents are incorporated herein by reference in their entirety.

### TECHNICAL FIELD

The present disclosure relates to the technical field of computer, and in particular, to a pose estimation method and device, an electronic apparatus, and a storage medium.

### BACKGROUND

In the related art, there is a need to match the points in three-dimensional space with the points in an image. As many points are to be matched, techniques such as neural network are often adopted to automatically gain matching relationships among a plurality of points. However, the matching relationships are generally inaccurate as a result of output errors and mutual interference among a plurality of adjacent points. Also, most of the matched points cannot represent the pose of a target object, so that a greater error occurs between the outputted pose and the real pose.

### SUMMARY

The present disclosure proposes a pose estimation method and device, an electronic apparatus, and a storage medium.

According to one aspect of the present disclosure, there is provided a pose estimation method, comprising:

performing keypoint detection processing on a target object in an image to be processed to obtain a plurality of keypoints of the target object in the image to be processed and a first covariance matrix corresponding to each keypoint, wherein the first covariance matrix is determined based on a position coordinate of the keypoint in the image to be processed and an estimated coordinate of the keypoint;

screening out a target keypoint from the plurality of keypoints in accordance with the first covariance matrix corresponding to each keypoint; and

performing pose estimation processing in accordance with the target keypoint to obtain a rotation matrix and a displacement vector.

According to the pose estimation method of the embodiments of the present disclosure, it is possible to obtain, by keypoint detection, keypoints in an image to be processed and the corresponding first covariance matrices; to remove, by screening keypoints in accordance with the first covariance matrices, mutual interference between the keypoints so as to increase accuracy of the matching relationship; and to remove, by screening the keypoints, keypoints that cannot represent the pose of a target object so as to reduce an error between an estimated pose and a real pose.

In a possible implementation, performing pose estimation processing in accordance with the target keypoint to obtain a rotation matrix and a displacement vector, comprises:

acquiring a space coordinate of the target keypoint in a three-dimensional coordinate system, wherein the space coordinate is a three-dimensional coordinate;

determining an initial rotation matrix and an initial displacement vector in accordance with the position coordinate of the target keypoint in the image to be processed and the space coordinate, wherein the position coordinate is a two-dimensional coordinate; and

adjusting, in accordance with the space coordinate and the position coordinate of the target keypoint in the image to be processed, the initial rotation matrix and the initial displacement vector to obtain the rotation matrix and the displacement vector.

In a possible implementation, adjusting, in accordance with the space coordinate and the position coordinate of the target keypoint in the image to be processed, the initial rotation matrix and the initial displacement vector to obtain the rotation matrix and the displacement vector, comprises:

performing, in accordance with the initial rotation matrix and the initial displacement vector, projection processing on the space coordinate to obtain a projected coordinate of the space coordinate in the image to be processed;

determining an error distance between the projected coordinate and the position coordinate of the target keypoint in the image to be processed;

adjusting the initial rotation matrix and the initial displacement vector in accordance with the error distance; and

obtaining the rotation matrix and the displacement vector in the case of error conditions met.

In a possible implementation, determining an error distance between the projected coordinate and the position coordinate of the target keypoint in the image to be processed, comprises:

obtaining a vector difference between a position coordinate and a projected coordinate of each target keypoint in the image to be processed, and a first covariance matrix corresponding to each target keypoint, respectively; and

determining the error distance in accordance with the vector difference and the first covariance matrix corresponding to each target keypoint.

In a possible implementation, performing keypoint detection processing on a target object in an image to be processed to obtain a plurality of keypoints of the target object in the image to be processed and a first covariance matrix corresponding to each keypoint, comprises:

performing keypoint detection processing on a target object in an image to be processed to obtain a plurality of estimated coordinates of each keypoint and a weight of each estimated coordinate;

performing weighted average processing on the plurality of estimated coordinates based upon the weight of each estimated coordinate, to obtain a position coordinate of the keypoint; and

obtaining a first covariance matrix corresponding to the keypoint in accordance with the plurality of estimated coordinates, the weight of each estimated coordinate, and the position coordinate of the keypoint.

In a possible implementation, obtaining a first covariance matrix corresponding to the keypoint in accordance with the plurality of estimated coordinates, the weight of each estimated coordinate, and the position coordinate of the keypoint, comprises:

determining a second covariance matrix between each estimated coordinate and the position coordinate of the keypoint; and

performing weighted average processing on a plurality of second covariance matrices based upon the weight of each estimated coordinate, to obtain the first covariance matrix corresponding to the keypoint.

In a possible implementation, performing keypoint detection processing on a target object in an image to be processed to obtain a plurality of estimated coordinates of each keypoint and a weight of each estimated coordinate, comprises:

performing keypoint detection processing on a target object in an image to be processed to obtain a plurality of initially estimated coordinates of the keypoint and a weight of each initially estimated coordinate; and

screening out, in accordance with the weight of each initially estimated coordinate, the estimated coordinate from the plurality of initially estimated coordinates.

In such a manner, screening out the estimated coordinates based upon weights may lessen computation load, improve processing efficiency, and remove outliers, such that the accuracy of the coordinate of a keypoint is increased.

In a possible implementation, screening out a target keypoint from the plurality of keypoints in accordance with the first covariance matrix corresponding to each keypoint, comprises:

determining a trace of the first covariance matrix corresponding to each keypoint;

screening out a preset number of first covariance matrices from the first covariance matrices corresponding to the keypoints, wherein a trace of a screened-out first covariance matrix is smaller than a trace of a first covariance matrix that is not screened out; and

determining the target keypoint based upon the preset number of first covariance matrices that are screened out.

In such a manner, it is possible to screen out keypoints, such that mutual interference among keypoints may be removed, and keypoints that cannot represent the pose of a target object may be removed, thereby increasing the pose estimation accuracy and improving processing efficiency.

According to another aspect of the present disclosure, there is provided a pose estimation device, comprising:

a detection unit, configured to perform keypoint detection processing on a target object in an image to be processed to obtain a plurality of keypoints of the target object in the image to be processed and a first covariance matrix corresponding to each keypoint, wherein the first covariance matrix is determined based on a position coordinate of the keypoint in the image to be processed and an estimated coordinate of the keypoint;

a screening module, configured to screen out a target keypoint from the plurality of keypoints in accordance with the first covariance matrix corresponding to each keypoint; and

a pose estimation module, configured to perform pose estimation processing in accordance with the target keypoint to obtain a rotation matrix and a displacement vector.

In a possible implementation, the pose estimation module is further configured to:

acquire a space coordinate of the target keypoint in a three-dimensional coordinate system, wherein the space coordinate is a three-dimensional coordinate;

determine an initial rotation matrix and an initial displacement vector in accordance with the position coordinate of the target keypoint in the image to be processed and the space coordinate, wherein the position coordinate is a two-dimensional coordinate; and

adjust, in accordance with the space coordinate and the position coordinate of the target keypoint in the image to be processed, the initial rotation matrix and the initial displacement vector to obtain the rotation matrix and the displacement vector.

In a possible implementation, the pose estimation module is further configured to:

perform, in accordance with the initial rotation matrix and the initial displacement vector, projection processing on the space coordinate to obtain a projected coordinate of the space coordinate in the image to be processed;

determine an error distance between the projected coordinate and the position coordinate of the target keypoint in the image to be processed;

adjust the initial rotation matrix and the initial displacement vector in accordance with the error distance; and

obtain the rotation matrix and the displacement vector in the case of error conditions met.

In a possible implementation, the pose estimation module is further configured to:

obtain a vector difference between a position coordinate and a projected coordinate of each target keypoint in the image to be processed, and a first covariance matrix corresponding to each target keypoint, respectively; and

determine the error distance in accordance with the vector difference and the first covariance matrix corresponding to each target keypoint.

In a possible implementation, the detection module is further configured to:

perform keypoint detection processing on a target object in an image to be processed to obtain a plurality of estimated coordinates of each keypoint and a weight of each estimated coordinate;

perform weighted average processing on the plurality of estimated coordinates based upon the weight of each estimated coordinate, to obtain a position coordinate of the keypoint; and

obtain a first covariance matrix corresponding to the keypoint in accordance with the plurality of estimated coordinates, the weight of each estimated coordinate, and the position coordinate of the keypoint.

In a possible implementation, the detection module is further configured to:

determine a second covariance matrix between each estimated coordinate and the position coordinate of the keypoint; and

perform weighted average processing on a plurality of second covariance matrices based upon the weight of each estimated coordinate, to obtain the first covariance matrix corresponding to the keypoint.

In a possible implementation, the detection module is further configured to:

perform keypoint detection processing on a target object in an image to be processed to obtain a plurality of initially estimated coordinates of the keypoint and a weight of each initially estimated coordinate; and

screen out, in accordance with the weight of each initially estimated coordinate, the estimated coordinate from the plurality of initially estimated coordinates.

In a possible implementation, the screening module is further configured to:

determine a trace of the first covariance matrix corresponding to each keypoint;

screen out a preset number of first covariance matrices from the first covariance matrices corresponding to the keypoints, wherein a trace of a screened-out first covariance matrix is smaller than a trace of a first covariance matrix that is not screened out; and

determine the target keypoint based upon the preset number of first covariance matrices that are screened out.

According to another aspect of the present disclosure, there is provided an electronic apparatus, comprising:

a processor; and

a memory configured to store processor-executable instructions;

wherein the processor is configured to execute the pose estimation method above.

According to another aspect of the present disclosure, there is provided a computer readable storage medium having computer program instructions stored thereon, wherein the computer program instructions, when executed by a processor, implement the pose estimation method above.

It should be understandable that the general description above and the following detailed description are merely exemplary and explanatory, instead of restricting the present disclosure.

Additional features and aspects of the present disclosure will become apparent from the following detailed description of exemplary embodiments with reference to the attached drawings.

### BRIEF DESCRIPTION OF THE DRAWINGS

The drawings herein, which are incorporated in and constitute part of the specification, together with the description, illustrate embodiments in line with the present disclosure and serve to explain the technical solutions of the present disclosure.

FIG. 1 shows a flow chart of the pose estimation method according to an embodiment of the present disclosure.

FIG. 2 shows a schematic diagram of keypoint detection according to an embodiment of the present disclosure.

FIG. 3 shows a schematic diagram of keypoint detection according to an embodiment of the present disclosure.

FIG. 4 is an application schematic diagram of the pose estimation method according to an embodiment of the present disclosure.

FIG. 5 shows a block diagram of the pose estimation device according to an embodiment of the present disclosure.

FIG. 6 shows a block diagram of the electronic apparatus according to an embodiment of the present disclosure.

FIG. 7 shows a block diagram of the electronic apparatus according to an embodiment of the present disclosure.

### DETAILED DESCRIPTION

Various exemplary examples, features and aspects of the present disclosure will be described in detail with reference to the drawings. The same reference numerals in the drawings represent parts having the same or similar functions. Although various aspects of the embodiments are shown in the drawings, it is unnecessary to proportionally draw the drawings unless otherwise specified.

Herein the specific term “exemplary” means “used as an instance or example, or explanatory”. An “exemplary” embodiment given here is not necessarily construed as being superior to or better than other examples.

The term “and/or” used herein represents only an association relationship for describing associated objects, and represents three possible relationships. For example, A and/or B may represent the following three cases: A exists alone, both A and B exist, and B exists alone. In addition, the term “at least one” used herein indicates any one of multiple listed items or any combination of at least two of multiple listed items. For example, including at least one of A, B, and C may indicate including any one or more elements selected from the group consisting of A, B, and C.

Numerous details are given in the following specific embodiments for the purpose of better explaining the present disclosure. It should be understood by a person skilled in the art that the present disclosure can still be realized even without some of those details. In some of the examples, methods, means, units and circuits that are well known to a person skilled in the art are not described in detail so that the principle of the present disclosure becomes apparent.

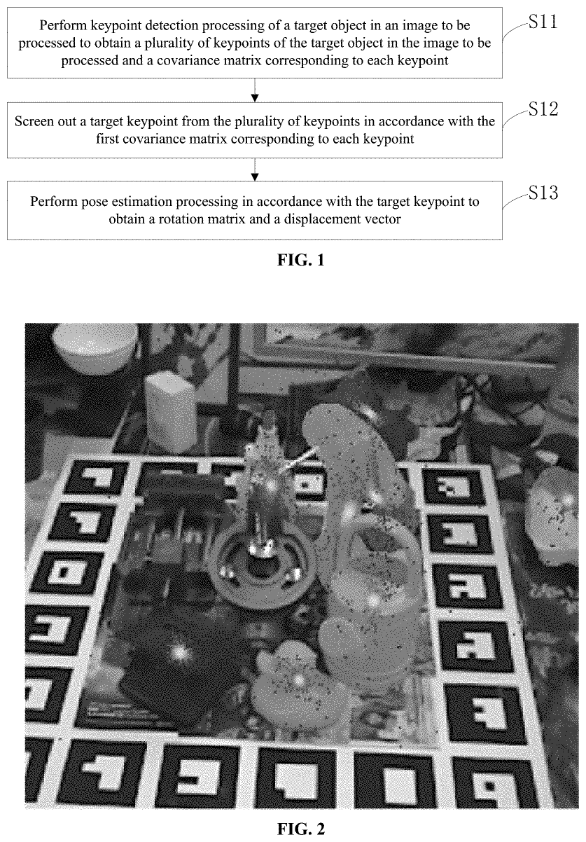

FIG. 1 shows a flow chart of the pose estimation method according to an embodiment of the present disclosure. As shown in FIG. 1, the method comprises:

Step S11: performing keypoint detection processing on a target object in an image to be processed to obtain a plurality of keypoints of the target object in the image to be processed and a first covariance matrix corresponding to each keypoint, wherein the first covariance matrix is determined based on a position coordinate of the keypoint in the image to be processed and an estimated coordinate of the keypoint;

Step S12: screening out a target keypoint from the plurality of keypoints in accordance with the first covariance matrix corresponding to each keypoint; and

Step S13: performing pose estimation processing in accordance with the target keypoint to obtain a rotation matrix and a displacement vector.

According to the pose estimation method of the embodiments of the present disclosure, it is possible to obtain, by keypoint detection, keypoints in an image to be processed and the corresponding first covariance matrices; to remove, by screening keypoints in accordance with the first covariance matrices, mutual interference between keypoints so as to increase accuracy of a matching relationship; and to remove, by screening keypoints, keypoints that cannot represent the pose of a target object to reduce an error between an estimated pose and a real pose.

In a possible implementation, a target object in an image to be processed is subjected to keypoint detection processing. The image to be processed may include a plurality of target objects that are located in each area of the image to be processed, respectively; or a target object in the image to be processed may occupy a plurality of areas, and the keypoint in each area is obtainable by keypoint detection processing. In an example, it is possible to obtain a plurality of estimated coordinates of the keypoint in each area, and to obtain a position coordinate of the keypoint in each area in accordance with the estimated coordinates. Furthermore, it is also possible to obtain, by the position coordinate and the estimated coordinates, a first covariance matrix corresponding to each keypoint.

In a possible implementation, Step S11 may comprises: performing keypoint detection processing on a target object in an image to be processed to obtain a plurality of estimated coordinates of each keypoint and a weight of each estimated coordinate; performing weighted average processing on the plurality of estimated coordinates based upon the weight of each estimated coordinate, to obtain a position coordinate of the keypoint; and obtaining a first covariance matrix corresponding to the keypoint in accordance with the plurality of estimated coordinates, the weight of each estimated coordinate, and the position coordinate of the keypoint.

In a possible implementation, an image to be processed may be processed by a pre-trained neural network, to obtain a plurality of estimated coordinates of a keypoint of a target object and a weight of each estimated coordinate. The neural network may be a convolutional neural network. The present disclosure does not limit the type of the neural network. In an example, the neural network may acquire estimated coordinates of the keypoint of each target object or estimated coordinates of the keypoint in each area of a target object, and a weight of each estimated coordinate. In an example, the estimated coordinates of a keypoint may also be obtained by approaches such as pixel processing. The present disclosure does not limit how to obtain the estimated coordinates of a keypoint.

In an example, the neural network may output an area where each pixel point in an image to be processed is located and a first direction vector directed to a keypoint in each area. For instance, if an image to be processed contains two target objects A and B (or an image to be processed contains only one target object, and the target object may be divided into two areas A and B), the image to be processed may be divided into three areas, namely, area A, area B, and background area C. An arbitrary parameter of an area may be used to indicate the area where a pixel point is located. For example, if a pixel point at coordinates (10, 20) is located in area A, this pixel point may be expressed as (10, 20, A); and if a pixel point at coordinates (50, 80) is located in the background area, this pixel point may be expressed as (50, 80, C). The first direction vector may be a unit vector, e.g., (0.707, 0.707). In an example, an area where a pixel point is located and a first direction vector may be expressed together with the coordinate of the pixel as (10, 20, A, 0.707, 0.707), for example.

In an example, in determining an estimated coordinate of a keypoint in a certain area (e.g., area A), it is possible to determine an intersection of the first direction vectors of any two pixel points in area A, and determine this intersection as one estimated coordinate of the keypoint. In such a manner, an intersection of any two of the first direction vectors may be acquired multiple times, namely, determining a plurality of estimated coordinates of the keypoint.

In an example, a weight of each estimated coordinate may be determined by the following formula (1):

$${w}_{k , i} = {\sum }_{{p}^{′} ∈ O} 𝕀 ( \frac{{( {h}_{k , i} - {p}^{′} )}^{T}}{{‖ {h}_{k , i} - {p}^{′} ‖}_{2}} {v}_{k} ( {p}^{′} ) \geq θ ) \qquad ( 1 )$$

wherein w_{k,i} is a weight of the ith keypoint estimated coordinate in the kth area (e.g., area A), O represents all pixel points in this area, p′ is an arbitrary pixel point in this area, h_{k,i} is the ith keypoint estimated coordinate in this area,

$$\frac{{( {h}_{k , i} - {p}^{′} )}^{T}}{{‖ {h}_{k , i} - {p}^{′} ‖}_{2}}$$

is a second direction vector of p′ directed to h_{k,i}, vₖ (p′) is a first direction vector of p′, θ is a predetermined threshold. In an example, θ may be 0.99, which is not limited in the present disclosure. And Π is an activation function indicating that if an inner product of

$$\frac{{( {h}_{k , i} - {p}^{′} )}^{T}}{{‖ {h}_{k , i} - {p}^{′} ‖}_{2}}$$

and vₖ(p′) is equal to or greater than the predetermined threshold θ, the value of Π is 1, or 0 otherwise. The formula (1) may indicate a result obtained by adding activation function values of all pixel points in a target area, i.e., a weight of a keypoint estimated coordinate h_{k,i}. The present disclosure does not limit the activation function value when an inner product is equal to or greater than the predetermined threshold.

In an example, it is possible to obtain, according to the aforesaid methods of obtaining a plurality of estimated coordinates of a keypoint and a weight of each estimated coordinate, a plurality of estimated coordinates of a keypoint in each area of a target object or a keypoint of each target object, and a weight of each estimated coordinate.

FIG. 2 shows a schematic diagram of keypoint detection according to an embodiment of the present disclosure. As shown in FIG. 2, it involves a plurality of target objects, and it is possible to obtain, via a neural network, estimated coordinates of the keypoint of each target object and a weight of each estimated coordinate.

In a possible implementation, weighted average processing may be performed on estimated coordinates of the keypoint in each area to obtain the position coordinate of the keypoint in each area. It is also possible to remove, by screening, estimated coordinates with smaller weights from a plurality of estimated coordinates of the keypoint for the purpose of decreasing computation load, while removing an outlier to increase accuracy of the coordinate of the keypoint.

In a possible implementation, performing keypoint detection processing on a target object in an image to be processed to obtain a plurality of estimated coordinates of each keypoint and a weight of each estimated coordinate, comprises: performing keypoint detection processing on a target object in an image to be processed to obtain a plurality of initially estimated coordinates of the keypoint and a weight of each initially estimated coordinate; and screening out, in accordance with the weight of each initially estimated coordinate, the estimated coordinate from the plurality of initially estimated coordinates.

In such a manner, screening out estimated coordinates based upon weights may lessen computation load, improve processing efficiency, and remove an outlier to increase accuracy of the coordinate of a keypoint.

In a possible implementation, it is possible to acquire, via a neural network, initially estimated coordinates of a keypoint and a weight of each initially estimated coordinate, and to screen out, from a plurality of initially estimated coordinates of the keypoint, the initially estimated coordinates that have a weight equal to or greater than the weight threshold, or some of the initially estimated coordinates with a greater weight (for example, the initially estimated coordinates are sorted according to the weights, and the first 20% of the initially estimated coordinates with the largest weight are screened out). The initially estimated coordinates that are screened out may be determined as the estimated coordinates, and the remaining initially estimated coordinates are removed. Further, weighted average processing may be performed on the estimated coordinates to obtain the position coordinate of the keypoint. In such a manner, the position coordinates of all keypoints are obtainable.

In a possible implementation, weighted average processing may be performed on the estimated coordinates to obtain the position coordinate of each keypoint. In an example, the position coordinate of the keypoint may be obtained by the following formula (2):

$${μ}_{k} = \frac{{\sum }_{i = 1}^{N} {w}_{k , i} {h}_{k , i}}{{\sum }_{i = 1}^{N} {w}_{k , i}} \qquad ( 2 )$$

wherein μₖ is a position coordinate of a keypoint obtained by performing weighted average processing on N keypoint estimated coordinates of the kth area (e.g., area A).

In a possible implementation, a first covariance matrix corresponding to a keypoint may be determined in accordance with a plurality of estimated coordinates of the keypoint, a weight of each estimated coordinate, and the position coordinate of the keypoint. In an example, obtaining a first covariance matrix corresponding to the keypoint in accordance with the plurality of estimated coordinates, the weight of each estimated coordinate, and the position coordinate of the keypoint, comprises: determining a second covariance matrix between each estimated coordinate and the position coordinate of the keypoint; and performing weighted average processing on a plurality of second covariance matrices based upon the weight of each estimated coordinate, to obtain the first covariance matrix corresponding to the keypoint.

In a possible implementation, the position coordinate of a keypoint is a coordinate obtained by weighted average of a plurality of estimated coordinates. A covariance matrix (namely, a second covariance matrix) of each estimated coordinate and the position coordinate of the keypoint may be obtained. Furthermore, weighted average processing may be performed on the second covariance matrices according to a weight of each estimated coordinate, to obtain the first covariance matrix.

In an example, the first covariance matrix Σₖ may be obtained by the following formula (3):

$${\sum }_{k} = \frac{{\sum }_{i = 1}^{N} {w}_{k , i} ( {h}_{k , i} - {μ}_{k} ) {( {h}_{k , i} - {μ}_{k} )}^{T}}{{\sum }_{i = 1}^{N} {w}_{k , i}} \qquad ( 3 )$$

In an example, estimated coordinates may not be screened out. Rather, it is possible to perform weighted average processing on all initially estimated coordinates of a keypoint to obtain the position coordinate of the keypoint; to obtain a covariance matrix between each initially estimated coordinate and the position coordinate; and to perform weighted average processing on the covariance matrices to obtain a first covariance matrix corresponding to the keypoint. Whether or not to screen out the initially estimated coordinates is not limited in the present disclosure.

FIG. 3 shows a schematic diagram of keypoint detection according to an embodiment of the present disclosure. As shown in FIG. 3, the probability distribution of a position of a keypoint in each area may be determined in accordance with the position coordinate of the keypoint in each area and the first covariance matrix. For instance, the ellipses on each target object in FIG. 3 may indicate probability distribution of a position of a keypoint, where the center (i.e., the “star” position) of an ellipse is the position coordinate of the keypoint in each area.

In a possible implementation, in Step S12, a target keypoint may be screened out according to a first covariance matrix corresponding to each keypoint. In an example, Step S12 may comprise: determining a trace of the first covariance matrix corresponding to each keypoint; screening out a preset number of first covariance matrices from the first covariance matrices corresponding to keypoints, wherein a trace of a screened-out first covariance matrix is smaller than a trace of a first covariance matrix that is not screened out; and determining the target keypoint based upon the preset number of first covariance matrices that are screened out.

In an example, a target object in an image to be processed may include a plurality of keypoints. It is possible to screen out a keypoint according to the trace of a first covariance matrix corresponding to each keypoint, and to calculate the trace of the covariance matrix corresponding to each keypoint, namely, a result obtained by adding elements on the leading diagonal of the first covariance matrix. Keypoints corresponding to a plurality of first covariance matrices with smaller traces may be screened out. In an example, a preset number of first covariance matrices may be screened out, wherein a trace of a screened-out first covariance matrix is smaller than a trace of a first covariance matrix that is not screened out. For example, the keypoints may be sorted according to magnitudes of traces, and a preset number of first covariance matrices, e.g., four of the first covariance matrices, with the minimum trace may be selected. Further, the keypoint corresponding to the screened-out first covariance matrix may be taken as a target keypoint. For example, four keypoints may be selected, that is, keypoints that may represent the pose of a target object may be screened out to eliminate the interference of other keypoints.

In such a manner, it is possible to screen out keypoints, such that mutual interference between keypoints may be removed, and keypoints that cannot represent the pose of a target object may be removed, thereby increasing pose estimation accuracy and improving processing efficiency.

In a possible implementation, in Step S13, pose estimation may be performed according to target keypoints to obtain a rotation matrix and a displacement vector.

In a possible implementation, Step S13 may comprise: acquiring a space coordinate of the target keypoint in a three-dimensional coordinate system, wherein the space coordinate is a three-dimensional coordinate; determining an initial rotation matrix and an initial displacement vector in accordance with the position coordinate of the target keypoint in the image to be processed and the space coordinate, wherein the position coordinate is a two-dimensional coordinate; and adjusting, in accordance with the space coordinate and the position coordinate of the target keypoint in the image to be processed, the initial rotation matrix and the initial displacement vector to obtain the rotation matrix and the displacement vector.

In a possible implementation, the three-dimensional coordinate system is an arbitrary space coordinate system established in the space where the target object is located. By performing three-dimensional modeling on a captured target object, for example, performing three-dimensional modeling by Computer Aided Design (CAD), it is possible to determine, in a three-dimensional model, a space coordinate of a point corresponding to a target keypoint.

In a possible implementation, an initial rotation matrix and an initial displacement vector may be determined by the position coordinate of a target keypoint in the image to be processed (namely, position coordinate of the target keypoint) and the space coordinate. In an example, the internal parameter matrix of a camera may be multiplied by the space coordinate of the target keypoint, and the result of the multiplication and the elements at the position coordinate of the target keypoint in the image to be processed may be processed via the least square method, to obtain an initial rotation matrix and an initial displacement vector.

In an example, the position coordinate of a target keypoint in the image to be processed and a three-dimensional coordinate of each target keypoint may be processed via EPnP (Efficient Perspective-n-Point Camera Pose Estimation) algorithm or Direct Linear Transform (DLT) algorithm, to obtain an initial rotation matrix and an initial displacement vector.

In a possible implementation, the initial rotation matrix and the initial displacement vector may be adjusted, so as to reduce an error between an estimated pose and the real pose of a target object.

In a possible implementation, adjusting, in accordance with the space coordinate and the position coordinate of the target keypoint in the image to be processed, the initial rotation matrix and the initial displacement vector to obtain the rotation matrix and the displacement vector, comprises: performing, in accordance with the initial rotation matrix and the initial displacement vector, projection processing on the space coordinate to obtain a projected coordinate of the space coordinate in the image to be processed; determining an error distance between the projected coordinate and the position coordinate of the target keypoint in the image to be processed; adjusting the initial rotation matrix and the initial displacement vector in accordance with the error distance; and obtaining the rotation matrix and the displacement vector in the case of error conditions met.

In a possible implementation, projection processing may be performed on a space coordinate according to the initial rotation matrix and the initial displacement vector, and a projected coordinate of the space coordinate in the image to be processed may be obtained. Further, it is possible to obtain an error distance between the projected coordinate and the position coordinate of each target keypoint in the image to be processed.

In a possible implementation, determining an error distance between the projected coordinate and the position coordinate of the target keypoint in the image to be processed, comprises: obtaining a vector difference between a position coordinate and a projected coordinate of each target keypoint in the image to be processed, and a first covariance matrix corresponding to each target keypoint, respectively; and determining the error distance in accordance with the vector difference and the first covariance matrix corresponding to each target keypoint.

In a possible implementation, it is possible to obtain an error difference between the projected coordinate of a space coordinate corresponding to a target keypoint and the position coordinate of the target keypoint in an image to be processed. For example, the vector difference may be obtained by subtracting the position coordinate of a certain target keypoint from the projected coordinate thereof, and the vector differences corresponding to all target keypoints may be obtained in this way.

In a possible implementation, an error distance may be determined by the following formula (4):

M=Σₖⁿ(\tilde{x}ₖ−μₖ)^{T}Σₖ⁻¹ (4)

wherein M is the error distance, i.e., Mahalanobis distance, n is the number of target keypoints, \tilde{x}ₖ is a projected coordinate of a three-dimensional coordinate of the target keypoint (namely, the kth target keypoint) in the kth area, μₖ is a position coordinate of the target keypoint, and Σₖ⁻¹ is an inverse matrix of a first covariance matrix corresponding to the target keypoint. That is, a vector difference corresponding to each target keypoint is multiplied by an inverse matrix of a first covariance matrix, and then the results of the multiplications are added to obtain the error distance M.

In a possible implementation, the initial rotation matrix and the initial displacement vector may be adjusted according to the error distance. In an example, parameters for the initial rotation matrix and the initial displacement vector may be adjusted, so as to shorten an error distance between the projected coordinate of the space coordinate and the position coordinate. In an example, it is possible to determine a gradient between an error distance and an initial rotation matrix and a gradient between an error distance and an initial displacement vector, respectively, and to adjust parameters for the initial rotation matrix and the initial displacement vector by gradient descent, so that the error distance is shortened.

In a possible implementation, the above-mentioned processing of adjusting the parameters for the initial rotation matrix and the initial displacement vector may be made in iterations, until error conditions are met. The error conditions may include conditions where the error distance is less than or equal to the error threshold, or where the parameters for the rotation matrix and the displacement vector no longer vary, etc. After the error conditions are met, the rotation matrix and displacement vector, whose parameters have been adjusted, may be used as the rotation matrix and displacement vector for pose estimation.

According to the pose estimation method of the embodiments of the present disclosure, it is possible to obtain, by keypoint detection, estimated coordinates of a keypoint in an image to be processed and a weight of each estimated coordinate, and to screen out an estimated coordinate according to the weight, which may reduce computation load and improve processing efficiency, and to remove an outlier, such that accuracy of the coordinate of a keypoint is increased. Furthermore, by screening out keypoints in accordance with the first covariance matrices, it is possible to remove mutual interference between keypoints so as to increase accuracy of a matching relationship, and to remove, by screening out keypoints, keypoints that cannot represent the pose of a target object to reduce an error between an estimated pose and a real pose and increase accuracy of the estimated pose.

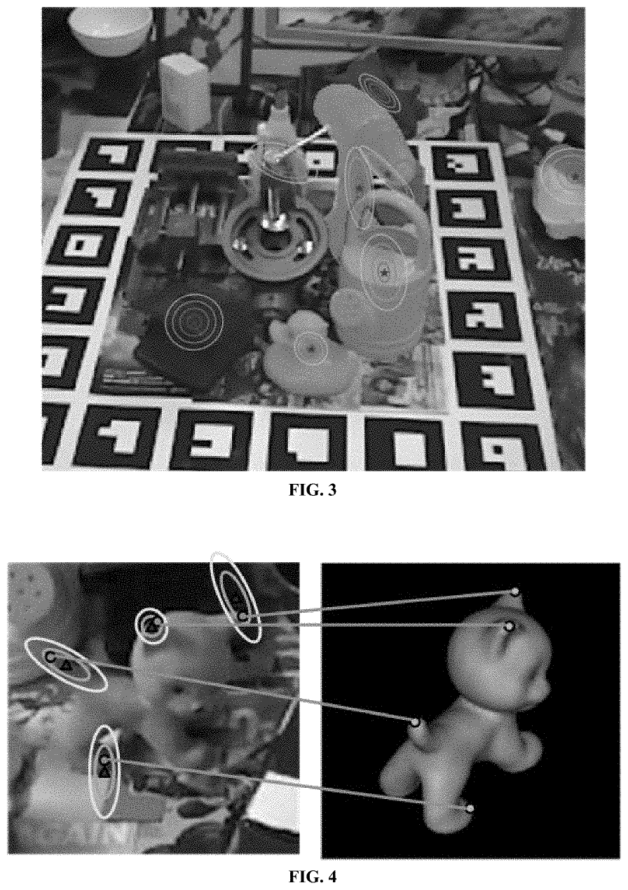

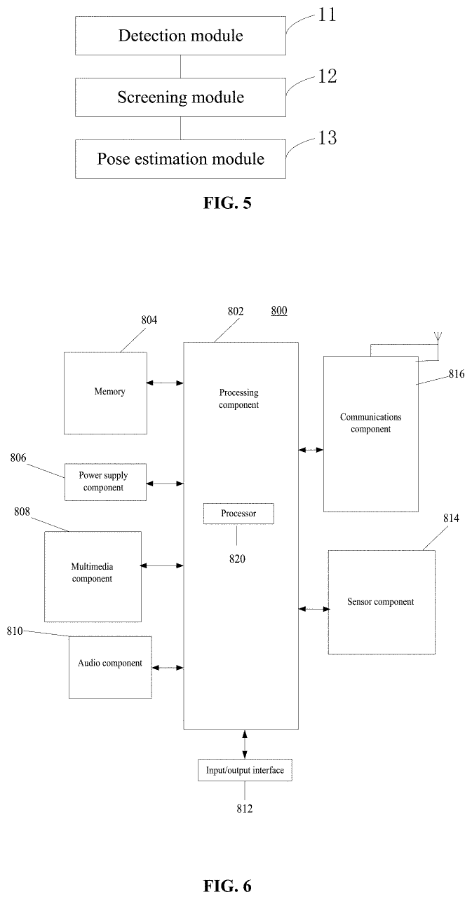

FIG. 4 is an application schematic diagram of the pose estimation method according to an embodiment of the present disclosure. As shown in FIG. 4, the left-hand side of FIG. 4 shows an image to be processed, which may be subjected to keypoint detection processing to obtain estimated coordinates of each keypoint in the image to be processed and weights.

In a possible implementation, 20% of the initially estimated coordinates with the largest weight may be screened out from the initially estimated coordinates of each keypoint as estimated coordinates, which are subjected to weighted average processing to obtain a position coordinate (shown by a triangle mark in the center of the ellipse area on the left-hand side of FIG. 4) of each keypoint.

In a possible implementation, a second covariance matrix between the estimated coordinate of the keypoint and the position coordinate may be determined, and weighted average processing is performed on the second covariance matrices of the estimated coordinates to obtain the first covariance matrix corresponding to each keypoint. As shown in the ellipse area on the left-hand side of FIG. 4, the probability distribution of the position of each keypoint may be determined by the position coordinate of each keypoint and the first covariance matrix of each keypoint.

In a possible implementation, the keypoints corresponding to four of the first covariance matrices with the minimum trace may be selected as target keypoints according to traces of the first covariance matrices of keypoints, and the target object in the image to be processed is modeled in three dimensions to obtain the space coordinates (as shown by the circular marks on the right-hand side of FIG. 4) of the target keypoints in the three-dimensional model.

In a possible implementation, the space coordinate of the target keypoint and the position coordinate may be processed via EPnP algorithm or DLT algorithm, to obtain an initial rotation matrix and an initial displacement vector, and the space coordinate of the target keypoint may be projected according to the initial rotation matrix and the initial displacement vector to obtain a projected coordinate (as shown by the circular marks on the left-hand side of FIG. 4).

In a possible implementation, an error distance may be calculated by formula (4), and a gradient between an error distance and an initial rotation matrix as well as a gradient between an error distance and an initial displacement vector may be determined, respectively. Furthermore, parameters for the initial rotation matrix and the initial displacement vector may be adjusted by gradient descent, so that the error distance is shortened.

In a possible implementation, in the case where an error distance is less than or equal to the error threshold, or where parameters for the rotation matrix and the displacement vector are no longer varied, the rotation matrix and displacement vector, whose parameters have been adjusted, may be used as the rotation matrix and displacement vector for pose estimation.

FIG. 5 shows a block diagram of the pose estimation device according to an embodiment of the present disclosure. As shown in FIG. 5, the device comprises:

detection module 11, configured to perform keypoint detection processing on a target object in an image to be processed to obtain a plurality of keypoints of the target object in the image to be processed and a first covariance matrix corresponding to each keypoint, wherein the first covariance matrix is determined based on a position coordinate of the keypoint in the image to be processed and an estimated coordinate of the keypoint;

screening module 12, configured to screen out a target keypoint from the plurality of keypoints in accordance with the first covariance matrix corresponding to each keypoint; and

pose estimation module 13, configured to perform pose estimation processing in accordance with the target keypoint to obtain a rotation matrix and a displacement vector.

In a possible implementation, the pose estimation module is further configured to:

acquire a space coordinate of the target keypoint in a three-dimensional coordinate system, wherein the space coordinate is a three-dimensional coordinate;

determine an initial rotation matrix and an initial displacement vector in accordance with the position coordinate of the target keypoint in the image to be processed and the space coordinate, wherein the position coordinate is a two-dimensional coordinate; and

adjust, in accordance with the space coordinate and the position coordinate of the target keypoint in the image to be processed, the initial rotation matrix and the initial displacement vector to obtain the rotation matrix and the displacement vector.

In a possible implementation, the pose estimation module is further configured to:

perform, in accordance with the initial rotation matrix and the initial displacement vector, projection processing on the space coordinate to obtain a projected coordinate of the space coordinate in the image to be processed;

determine an error distance between the projected coordinate and the position coordinate of the target keypoint in the image to be processed;

adjust the initial rotation matrix and the initial displacement vector in accordance with the error distance; and

obtain the rotation matrix and the displacement vector in the case of error conditions met.

In a possible implementation, the pose estimation module is further configured to: obtain a vector difference between a position coordinate and a projected coordinate of each target keypoint in the image to be processed, and a first covariance matrix corresponding to each target keypoint, respectively; and

determine the error distance in accordance with the vector difference and the first covariance matrix corresponding to each target keypoint.

In a possible implementation, the detection module is further configured to:

perform keypoint detection processing on a target object in an image to be processed to obtain a plurality of estimated coordinates of each keypoint and a weight of each estimated coordinate;

perform weighted average processing on the plurality of estimated coordinates based upon the weight of each estimated coordinate, to obtain a position coordinate of the keypoint; and

obtain a first covariance matrix corresponding to the keypoint in accordance with the plurality of estimated coordinates, the weight of each estimated coordinate, and the position coordinate of the keypoint.

In a possible implementation, the detection module is further configured to:

determine a second covariance matrix between each estimated coordinate and the position coordinate of the keypoint; and

perform weighted average processing on a plurality of second covariance matrices based upon the weight of each estimated coordinate, to obtain the first covariance matrix corresponding to the keypoint.

In a possible implementation, the detection module is further configured to:

perform keypoint detection processing on a target object in an image to be processed to obtain a plurality of initially estimated coordinates of the keypoint and a weight of each initially estimated coordinate; and

screen out, in accordance with the weight of each initially estimated coordinate, the estimated coordinate from the plurality of initially estimated coordinates.

In a possible implementation, the screening module is further configured to:

determine a trace of the first covariance matrix corresponding to each keypoint;

screen out a preset number of first covariance matrices from the first covariance matrices corresponding to keypoints, wherein a trace of a screened-out first covariance matrix is smaller than a trace of a first covariance matrix that is not screened out; and

determine the target keypoint based upon the preset number of first covariance matrices that are screened out.

It is understandable that the above-mentioned method embodiments of the present disclosure may be combined with one another to form a combined embodiment without departing from the principle and the logics, which, due to limited space, will not be repeatedly described in the present disclosure.

In addition, the present disclosure further provides a pose estimation device, an electronic apparatus, a computer readable medium, and a program, which are all capable of realizing any one of the pose estimation methods provided in the present disclosure. For the corresponding technical solution and descriptions which will not be repeated, reference may be made to the corresponding descriptions of the method.

A person skilled in the art may understand that, in the foregoing method according to specific embodiments, the order of describing the steps does not means a strict order of execution that imposes any limitation on the implementation process. Rather, a specific order of execution of the steps should depend on the functions and possible inherent logics of the steps.

In some embodiments, functions of or modules included in the device provided in the embodiments of the present disclosure may be configured to execute the method described in the foregoing method embodiments. For specific implementation of the functions or modules, reference may be made to descriptions of the foregoing method embodiments. For brevity, details are not described here again.

The embodiments of the present disclosure further propose a computer readable storage medium having computer program instructions stored thereon, wherein the computer program instructions, when executed by a processor, implement the method above. The computer readable storage medium may be a non-volatile computer readable storage medium.

The embodiments of the present disclosure further propose an electronic apparatus, comprising: a processor; and a memory configured to store processor-executable instructions; wherein the processor is configured to carry out the method above.

The embodiments of the present disclosure further provide a computer program product, comprising a computer readable code, wherein when the computer readable code operates in an apparatus, a processor of the apparatus executes instructions for implementing the pose estimation method provided in any one of the embodiments above.

The embodiments of the present disclosure further provide another computer program product, configured to store computer readable instructions, wherein the instructions, when executed, enable the computer to execute operations of the pose estimation method provided in any one of the embodiments above.

The computer program product may specifically be implemented by hardware, software, or a combination thereof. In an optional embodiment, the computer program product is specifically embodied as a computer storage medium. In another optional embodiment, the computer program product is specifically embodied as a software product, e.g., Software Development Kit (SDK) and so forth.

The electronic apparatus may be provided as a terminal, a server, or an apparatus in other forms.

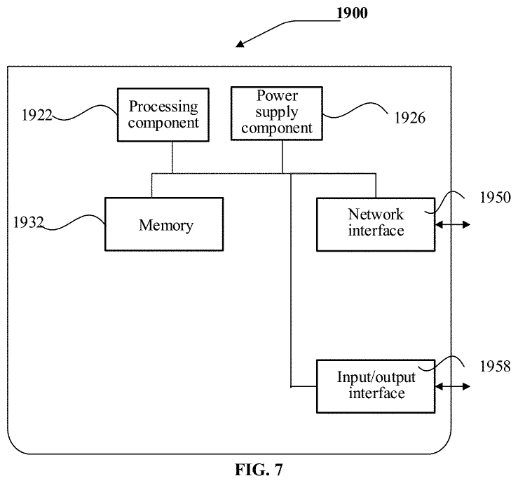

FIG. 6 shows a block diagram for an electronic apparatus 800 according to an exemplary embodiment. For example, electronic apparatus 800 may be a mobile phone, a computer, a digital broadcasting terminal, a message transmitting and receiving apparatus, a game console, a tablet apparatus, medical equipment, fitness equipment, a personal digital assistant, and other terminals.

Referring to FIG. 6, electronic apparatus 800 may include one or more of the following components: a processing component 802, a memory 804, a power component 806, a multimedia component 808, an audio component 810, an input/output (I/O) interface 812, a sensor component 814, and a communication component 816.

Processing component 802 is configured usually to control overall operations of electronic apparatus 800, such as the operations associated with display, telephone calls, data communications, camera operations, and recording operations. Processing component 802 can include one or more processors 820 configured to execute instructions to perform all or part of the steps included in the above-described methods. In addition, processing component 802 may include one or more modules configured to facilitate the interaction between the processing component 802 and other components. For example, processing component 802 may include a multimedia module configured to facilitate the interaction between multimedia component 808 and processing component 802.

Memory 804 is configured to store various types of data to support the operation of electronic apparatus 800. Examples of such data include instructions for any applications or methods operated on or performed by electronic apparatus 800, contact data, phonebook data, messages, pictures, video, etc. Memory 804 may be implemented using any type of volatile or non-volatile memory apparatus, or a combination thereof, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk, or an optical disk.

Power component 806 is configured to provide power to various components of electronic apparatus 800. Power component 806 may include a power management system, one or more power sources, and any other components associated with the generation, management, and distribution of power in electronic apparatus 800.

Multimedia component 808 includes a screen providing an output interface between electronic apparatus 800 and the user. In some embodiments, the screen may include a liquid crystal display (LCD) and a touch panel (TP). If the screen includes the touch panel, the screen may be implemented as a touch screen to receive input signals from the user. The touch panel may include one or more touch sensors configured to sense touches, swipes, and gestures on the touch panel. The touch sensors may sense not only a boundary of a touch or swipe action, but also a period of time and a pressure associated with the touch or swipe action. In some embodiments, multimedia component 808 may include a front camera and/or a rear camera. The front camera and/or the rear camera may receive an external multimedia datum while electronic apparatus 800 is in an operation mode, such as a photographing mode or a video mode. Each of the front camera and the rear camera may be a fixed optical lens system or may have focus and/or optical zoom capabilities.

Audio component 810 is configured to output and/or input audio signals. For example, audio component 810 may include a microphone (MIC) configured to receive an external audio signal when electronic apparatus 800 is in an operation mode, such as a call mode, a recording mode, and a voice recognition mode. The received audio signal may be further stored in memory 804 or transmitted via communication component 816. In some embodiments, audio component 810 further includes a speaker configured to output audio signals.

I/O interface 812 is configured to provide an interface between processing component 802 and peripheral interface modules, such as a keyboard, a click wheel, buttons, and the like. The buttons may include, but are not limited to, a home button, a volume button, a starting button, and a locking button.

Sensor component 814 includes one or more sensors configured to provide status assessments of various aspects of electronic apparatus 800. For example, sensor component 814 may detect at least one of an open/closed status of electronic apparatus 800, relative positioning of components, e.g., the components being the display and the keypad of the electronic apparatus 800. The sensor component 814 may further detect a change of position of the electronic apparatus 800 or one component of the electronic apparatus 800, presence or absence of contact between the user and the electronic apparatus 800, location or acceleration/deceleration of the electronic apparatus 800, and a change of temperature of the electronic apparatus 800. Sensor component 814 may include a proximity sensor configured to detect the presence of nearby objects without any physical contact. Sensor component 814 may also include a light sensor, such as a CMOS or CCD image sensor, for use in imaging applications. In some embodiments, sensor component 814 may also include an accelerometer sensor, a gyroscope sensor, a magnetic sensor, a pressure sensor, or a temperature sensor.

Communication component 816 is configured to facilitate wired or wireless communication between electronic apparatus 800 and other apparatus. Electronic apparatus 800 can access a wireless network based on a communication standard, such as WiFi, 2G, or 3G, or a combination thereof. In an exemplary embodiment, communication component 816 receives a broadcast signal or broadcast associated information from an external broadcast management system via a broadcast channel. In an exemplary embodiment, communication component 816 may include a near field communication (NFC) module to facilitate short-range communications. For example, the NFC module may be implemented based on a radio frequency identification (RFID) technology, an infrared data association (IrDA) technology, an ultra-wideband (UWB) technology, a Bluetooth (BT) technology, or any other suitable technologies.

In exemplary embodiments, the electronic apparatus 800 may be implemented with one or more application specific integrated circuits (ASICs), digital signal processors (DSPs), digital signal processing devices (DSPDs), programmable logic devices (PLDs), field programmable gate arrays (FPGAs), controllers, micro-controllers, microprocessors, or other electronic components, for performing the above-described methods.

In exemplary embodiments, there is also provided a non-volatile computer readable storage medium including instructions, such as those included in memory 804, executable by processor 820 of electronic apparatus 800, for completing the above-described methods.

FIG. 7 is another block diagram showing an electronic apparatus 1900 according to an exemplary embodiment. For example, the electronic apparatus 1900 may be provided as a server. Referring to FIG. 7, the electronic apparatus 1900 includes a processing component 1922, which further includes one or more processors, and a memory resource represented by a memory 1932 configured to store instructions such as application programs executable for the processing component 1922. The application programs stored in the memory 1932 may include one or more than one module of which each corresponds to a set of instructions. In addition, the processing component 1922 is configured to execute the instructions to execute the above-mentioned methods.

The electronic apparatus 1900 may further include a power component 1926 configured to execute power management of the electronic apparatus 1900, a wired or wireless network interface 1950 configured to connect the electronic apparatus 1900 to a network, an Input/Output (I/O) interface 1958. The electronic apparatus 1900 may be operated on the basis of an operating system stored in the memory 1932, such as Windows Server™, Mac OS X™, Unix™, Linux™ or FreeBSD™.

In exemplary embodiments, there is also provided a nonvolatile computer readable storage medium including instructions, for example, memory 1932 including computer program instructions, which are executable by processing component 1922 of the electronic apparatus 1900, to complete the above-described methods.

The present disclosure may be a system, a method, and/or a computer program product. The computer program product may include a computer readable storage medium having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowcharts and/or block diagrams of methods, device (systems), and computer program products according to embodiments of the present disclosure. It will be appreciated that each block of the flowcharts and/or block diagrams, and combinations of blocks in the flowcharts and/or block diagrams, can be implemented by computer readable program instructions.

These computer readable program instructions may be provided to a processor of a general purpose computer, special purpose computer, or other programmable data processing devices to produce a machine, such that the instructions, which execute via the processor of the computer or other programmable data processing devices, create means for implementing the functions/acts specified in the flowchart and/or block diagram block or blocks. These computer readable program instructions may also be stored in a computer readable storage medium that can direct a computer, a programmable data processing device, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing devices, or other device to cause a series of operational steps to be performed on the computer, other programmable devices or other device to produce a computer implemented process, such that the instructions which execute on the computer, other programmable devices, or other device implement the functions/acts specified in the flowchart and/or block diagram block or blocks.

The flowcharts and block diagrams in the drawings illustrate the architecture, functionality, and operation of possible implementations of systems, methods and computer program products according to various embodiments of the present disclosure. In this regard, each block in the flowcharts or block diagrams may represent a module, program segment, or portion of instruction, which comprises one or more executable instructions for implementing the specified logical function(s). In some alternative implementations, the functions noted in the block may occur out of the order noted in the drawings. For example, two blocks shown in succession may, in fact, be executed substantially concurrently, or the blocks may sometimes be executed in the reverse order, depending upon the functionality involved. It will also be noted that each block of the block diagrams and/or flowcharts, and combinations of blocks in the block diagrams and/or flowcharts, can be implemented by special purpose hardware-based systems that perform the specified functions or acts, or combinations of special purpose hardware and computer instructions.

Although the embodiments of the present disclosure have been described above, the foregoing descriptions are exemplary but not exhaustive, and the disclosed embodiments are not limiting. For a person skilled in the art, a number of modifications and variations are obvious without departing from the scope and spirit of the described embodiments. The terms used herein are intended to provide the best explanations on the principles of the embodiments, practical applications, or technical improvements to the technologies in the market, or to make the embodiments described herein understandable to other persons skilled in the art.

What is claimed is:

1. A pose estimation method, wherein the method comprises:
performing keypoint detection processing on a target object in an image to be processed to obtain a plurality of keypoints of the target object in the image to be processed and a first covariance matrix corresponding to each keypoint, wherein the first covariance matrix is determined based on a position coordinate of the keypoint in the image to be processed and an estimated coordinate of the keypoint;
screening out a target keypoint from the plurality of keypoints in accordance with the first covariance matrix corresponding to each keypoint; and
performing pose estimation processing in accordance with the target keypoint to obtain a rotation matrix and a displacement vector.

2. The method according to claim 1, wherein performing pose estimation processing in accordance with the target keypoint to obtain a rotation matrix and a displacement vector, comprises:
acquiring a space coordinate of the target keypoint in a three-dimensional coordinate system, wherein the space coordinate is a three-dimensional coordinate;
determining an initial rotation matrix and an initial displacement vector in accordance with the position coordinate of the target keypoint in the image to be processed and the space coordinate, wherein the position coordinate is a two-dimensional coordinate; and
adjusting, in accordance with the space coordinate and the position coordinate of the target keypoint in the image to be processed, the initial rotation matrix and the initial displacement vector to obtain the rotation matrix and the displacement vector.

3. The method according to claim 2, wherein adjusting, in accordance with the space coordinate and the position coordinate of the target keypoint in the image to be processed, the initial rotation matrix and the initial displacement vector to obtain the rotation matrix and the displacement vector, comprises:
performing, in accordance with the initial rotation matrix and the initial displacement vector, projection processing on the space coordinate to obtain a projected coordinate of the space coordinate in the image to be processed;
determining an error distance between the projected coordinate and the position coordinate of the target keypoint in the image to be processed;
adjusting the initial rotation matrix and the initial displacement vector in accordance with the error distance; and
obtaining the rotation matrix and the displacement vector in the case of error conditions met.

4. The method according to claim 3, wherein determining an error distance between the projected coordinate and the position coordinate of the target keypoint in the image to be processed, comprises:
obtaining a respective vector difference between a respective position coordinate and a respective projected coordinate of each target keypoint in the image to be processed, and a respective first covariance matrix corresponding to each target keypoint, respectively; and
determining a respective error distance in accordance with the respective vector difference and the respective first covariance matrix corresponding to each target keypoint.

5. The method according to claim 1, wherein performing keypoint detection processing on a target object in an image to be processed to obtain a plurality of keypoints of the target object in the image to be processed and a first covariance matrix corresponding to each keypoint, comprises:
performing keypoint detection processing on a target object in an image to be processed to obtain a plurality of estimated coordinates of each keypoint and a weight of each estimated coordinate;
performing weighted average processing on the plurality of estimated coordinates based upon the weight of each estimated coordinate, to obtain a position coordinate of the keypoint; and
obtaining a first covariance matrix corresponding to the keypoint in accordance with the plurality of estimated coordinates, the weight of each estimated coordinate, and the position coordinate of the keypoint.

6. The method according to claim 5, wherein obtaining a first covariance matrix corresponding to the keypoint in accordance with the plurality of estimated coordinates, the weight of each estimated coordinate, and the position coordinate of the keypoint, comprises:
determining a second covariance matrix between each estimated coordinate and the position coordinate of the keypoint; and
performing weighted average processing on a plurality of second covariance matrices based upon the weight of each estimated coordinate, to obtain the first covariance matrix corresponding to the keypoint.

7. The method according to claim 5, wherein performing keypoint detection processing on a target object in an image to be processed to obtain a plurality of estimated coordinates of each keypoint and a weight of each estimated coordinate, comprises:
performing keypoint detection processing on a target object in an image to be processed to obtain a plurality of initially estimated coordinates of the keypoint and a weight of each initially estimated coordinate; and
screening out, in accordance with the weight of each initially estimated coordinate, the estimated coordinate from the plurality of initially estimated coordinates.

8. The method according to claim 1, wherein screening out a target keypoint from the plurality of keypoints in accordance with the first covariance matrix corresponding to each keypoint, comprises:
determining a trace of the first covariance matrix corresponding to each keypoint;
screening out a preset number of first covariance matrices from the first covariance matrices corresponding to the keypoints, wherein a trace of a screened-out first covariance matrix is smaller than a trace of a first covariance matrix that is not screened out; and
determining the target keypoint based upon the preset number of first covariance matrices that are screened out.

9. A pose estimation device, comprising:
a processor; and
a memory configured to store processor-executable instructions,
wherein the processor is configured to invoke the instructions stored in the memory, so as to:
perform keypoint detection processing on a target object in an image to be processed to obtain a plurality of keypoints of the target object in the image to be processed and a first covariance matrix corresponding to each keypoint, wherein the first covariance matrix is determined based on a position coordinate of the keypoint in the image to be processed and an estimated coordinate of the keypoint;
screen out a target keypoint from the plurality of keypoints in accordance with the first covariance matrix corresponding to each keypoint; and
perform pose estimation processing in accordance with the target keypoint to obtain a rotation matrix and a displacement vector.

10. The device according to claim 9, wherein performing pose estimation processing in accordance with the target keypoint to obtain the rotation matrix and the displacement vector comprises:
acquiring a space coordinate of the target keypoint in a three-dimensional coordinate system, wherein the space coordinate is a three-dimensional coordinate;
determining an initial rotation matrix and an initial displacement vector in accordance with the position coordinate of the target keypoint in the image to be processed and the space coordinate, wherein the position coordinate is a two-dimensional coordinate; and
adjusting, in accordance with the space coordinate and the position coordinate of the target keypoint in the image to be processed, the initial rotation matrix and the initial displacement vector to obtain the rotation matrix and the displacement vector.

11. The device according to claim 10, wherein adjusting, in accordance with the space coordinate and the position coordinate of the target keypoint in the image to be processed, the initial rotation matrix and the initial displacement vector to obtain the rotation matrix and the displacement vector comprises:
performing, in accordance with the initial rotation matrix and the initial displacement vector, projection processing on the space coordinate to obtain a projected coordinate of the space coordinate in the image to be processed;
determining an error distance between the projected coordinate and the position coordinate of the target keypoint in the image to be processed;
adjusting the initial rotation matrix and the initial displacement vector in accordance with the error distance; and
obtaining the rotation matrix and the displacement vector in the case of error conditions met.

12. The device according to claim 11, wherein determining the error distance between the projected coordinate and the position coordinate of the target keypoint in the image to be processed comprises:
obtaining a respective vector difference between a respective position coordinate and a respective projected coordinate of each target keypoint in the image to be processed, and a respective first covariance matrix corresponding to each target keypoint, respectively; and
determining a respective error distance in accordance with the respective vector difference and the respective first covariance matrix corresponding to each target keypoint.

13. The device according to claim 9, wherein performing keypoint detection processing on the target object in the image to be processed to obtain the plurality of keypoints of the target object in the image to be processed and the first covariance matrix corresponding to each keypoint comprises:
performing keypoint detection processing on a target object in an image to be processed to obtain a plurality of estimated coordinates of each keypoint and a weight of each estimated coordinate;
performing weighted average processing on the plurality of estimated coordinates based upon the weight of each estimated coordinate, to obtain a position coordinate of the keypoint; and
obtaining a first covariance matrix corresponding to the keypoint in accordance with the plurality of estimated coordinates, the weight of each estimated coordinate, and the position coordinate of the keypoint.

14. The device according to claim 13, wherein obtaining a first covariance matrix corresponding to the keypoint in accordance with the plurality of estimated coordinates, the weight of each estimated coordinate, and the position coordinate of the keypoint comprises:
determining a second covariance matrix between each estimated coordinate and the position coordinate of the keypoint; and
performing weighted average processing on a plurality of second covariance matrices based upon the weight of each estimated coordinate, to obtain the first covariance matrix corresponding to the keypoint.

15. The device according to claim 13, wherein performing the keypoint detection processing on the target object in the image to be processed to obtain the plurality of keypoints of the target object in the image to be processed and the first covariance matrix corresponding to each keypoint comprises:
performing keypoint detection processing on a target object in an image to be processed to obtain a plurality of initially estimated coordinates of the keypoint and a weight of each initially estimated coordinate; and
screening out, in accordance with the weight of each initially estimated coordinate, the estimated coordinate from the plurality of initially estimated coordinates.

16. The device according to claim 9, wherein screening out the target keypoint from the plurality of keypoints in accordance with the first covariance matrix corresponding to each keypoint comprises:
determining a trace of the first covariance matrix corresponding to each keypoint;
screening out a preset number of first covariance matrices from the first covariance matrices corresponding to the keypoints, wherein a trace of a screened-out first covariance matrix is smaller than a trace of a first covariance matrix that is not screened out; and
determining the target keypoint based upon the preset number of first covariance matrices that are screened out.

17. A non-transitory computer readable storage medium having computer program instructions stored thereon, wherein the computer program instructions, when executed by a processor, implement the operations of:
performing keypoint detection processing on a target object in an image to be processed to obtain a plurality of keypoints of the target object in the image to be processed and a first covariance matrix corresponding to each keypoint, wherein the first covariance matrix is determined based on a position coordinate of the keypoint in the image to be processed and an estimated coordinate of the keypoint;
screening out a target keypoint from the plurality of keypoints in accordance with the first covariance matrix corresponding to each keypoint; and
performing pose estimation processing in accordance with the target keypoint to obtain a rotation matrix and a displacement vector.
